(19) United States
(12) Patent Application Publication
(10) Pub. No.: US 2007/0110934 A1
(43) Pub. Date: May 17, 2007

(54) Container closure with a multi-layer oxygen barrier liner

(75) Inventor: Anatoliy Goldman, Indianapolis, IN (US)

Correspondence Address: WOOD, PHILLIPS, KATZ, CLARK & MORTIMER, 500 W. MADISON STREET, SUITE 3800, CHICAGO, IL, 60661, US

(73) Assignee: Alcoa Closure Systems International, Inc.

(21) Appl. No.: 11/653,678

(22) Filed: Jan. 16, 2007

Related U.S. Application Data
(63) Continuation of application No. 10/282,583, filed on Oct. 29, 2002.

(51) Int. Cl. B32B 27/08

(52) U.S. Cl. 428/35.7

(57) ABSTRACT

A container closure with a multiple layer liner. The liner comprises a nylon gas transmission barrier and a non-nylon layer bonded by an adhesive layer. The nylon gas transmission barrier may contain an additional passive gas transmission component comprising an in-situ polymerized inorganic clay. An additional active gas transmission component comprising a chemically reactive scavenger may be incorporated into at least one layer of the multiple layer liner. Materials of the liner are selected for their process conditions and resulting resistance to degradation.

### FIELD OF THE INVENTION

This invention is directed to container closures that provide a barrier to gases, particularly oxygen, carbon dioxide and nitrogen, that may transfer to or from the container sealed by the closure. The invention particularly pertains to a multiple layer closure liner with a nylon gas barrier, and at least one associated layer which provides the desired mechanical sealing with a container. Alternatively or additionally, a scavenging material may be incorporated into the nylon and/or non-nylon layers of the liner. Nanoparticles may be incorporated into the passive nylon barrier layer.

### BACKGROUND OF THE INVENTION

Closures for containers are effective barriers if the closures can both be adequately sealed onto a container after the container is filled, and can be subsequently opened easily by a consumer. To this end, so-called composite closure constructions, including an outer molded plastic shell, and an inner, disc-like sealing liner, have proven to be highly commercially successful, providing the desired sealing properties, while facilitating convenient consumer use. Closures of this type are illustrated in U.S. Pat. Nos. 4,497,765 and 4,938,370, both hereby incorporated by reference.

Container closures that are designed to prevent the transfer of gases to or from the container may include a liner that may be made of multiple layers. Ethylene vinyl acetate (“EVA”) is a common liner material and is known to provide a suitable seal of the closure to the container while also maintaining an opening torque in a range that is easily applied by the end user or consumer.

EVA closure liners are known to have a relatively high gas transmission rate, which presents a particular problem when the container to be sealed contains a carbonated beverage. In order to maintain the carbonated quality of the beverage, a particular carbon dioxide gas pressure must be maintained in the container. Carbonated beverages have a limited shelf life due, at least in part, to the gas transmission properties of the EVA liner.

Another problem with liners or closures that have a relatively high gas transmission rate is that oxygen may enter the container. Oxygen can degrade the taste of a carbonated beverage over time and may adversely effect other properties of the product in the container. This can be particularly problematic in the case of beer and other fermented beverages.

Reduction of gas transmission to or from containers has been improved by careful selection of container materials, however, a significant amount of gas transmission to or from the container still takes place through the closure. Some container formulations have included types of nylon. Closure liners that have been designed to reduce the amount of gas transmission through the closure have included polyvinylidene chloride (“PVDC”), polyethylene naphthalene (“PEN”), ethylene vinyl alcohol co-polymer (“EVOH”), and mixtures of these polymers. Because the EVA material does not provide a complete barrier to gas transfer this material has been layered with other compositions but, where EVA is tied to polyolefinic layers, the layers may delaminate in a relatively short period of time.

Metal or plastic closures for use with containers carrying beer, juice or soft drinks have included liners of a polymeric heterogeneous blend of unvulcanized and uncrosslinked butyl rubber and a thermoplastic polymer. Foamed polymer sealing layers have been used to retard, but not completely prevent, the migration of oxygen and carbon dioxide through container closures. However, the shelf life of products with these foamed liners may be only slightly improved with a retardation of oxygen migration, as there exists an obvious relationship between the rate of oxygen ingress to the container and the shelf life of the product.

Multiple layer closure liners have been used to inhibit gas transfer to and from containers. One example of a multiple layer closure liner has a gas barrier layer of ethylene vinyl alcohol copolymer (“EVOH”) sandwiched between layers of EVA. These liners are formed by coextrusion process to prevent the gas barrier layer from being exposed to moisture. The EVOH barrier liners typically were comprised of nine coextruded layers. The layers of such liners may be bonded via an adhesive, or tie, layer to polyolefinic layers. These liners also may delaminate in a short period of time. Also, the effectiveness of EVOH as a barrier is reduced in environments with greater than about 70-80% of relative humidity. In container headspace, such as that for soft drink bottles, relative humidity may reach levels of 95-100%. Liners of this type were generally expensive and did not perform well.

Accordingly, there exists a need for a closure liner that provides an improved barrier to gas transfer to and from the container. There is further a need for such liners to avoid degradation while maintaining or improving the ease of manufacture of the liners.

The invention provides such a liner and method for making the liner that results in a closure that is more impervious to gas transfer, resists degradation and delamination and is easily manufactured. These and other advantages of the invention, as well as additional inventive features, will be apparent from the description of the invention provided herein.

### BRIEF SUMMARY OF THE INVENTION

The multiple layer liners of the present invention are for container closures that inhibit ingress of oxygen and egress carbon dioxide or other transfer gases into and from the container. Closures with liners of the type described here are particularly useful for sealing and storing bottles of beverages that are subject to taste degradation or reductions in quality associated with a loss of carbonation or introduction of oxygen. Such beverages in particular include carbonated soft drinks and beer.

The invention provides a container closure with an outer shell having a top wall portion and a cylindrical side wall portion depending from the top wall portion. The closure includes a multiple layer liner positioned adjacent to an inside surface of the outer shell. The liner includes at least one nylon barrier layer, at least one non-nylon layer, and an adhesive layer bonding the nylon barrier layer to non-nylon layer.

In one form, the non-nylon material is an ethylene vinyl acetate-based material. In another form, the non-nylon layer is a combination of ethylene vinyl acetate and a polyolefinic material.

In anther form of the invention, the closure further comprises an active scavenging material within the layer of ethylene vinyl acetate-based material. In a further form, the active scavenging material is selected specifically to react with a chemical selected from the group consisting of oxygen, carbon dioxide and nitrogen.

In one form, the passive nylon barrier incorporates inorganic nanoparticles, such as mineral clay material, as a passive barrier to gas transmission. The incorporation of the nanoparticles is accomplished by an in situ polymerization method. Alternatively or additionally, a reactive scavenging material may be incorporated into the nylon and/or non-nylon layers of the liner.

In a preferred embodiment, the passive nylon barrier layer, EVA layer, and the adhesive layer originate from materials having processing parameters in overlapping and/or adjacent ranges. The resulting multiple-layer liners have an adhesive strength of at least 8.5 pounds per inch.

In one form the invention is a process for manufacturing a container closure liner, the process includes the steps of selecting a nylon barrier material having a range of processing parameters, selecting a material based on ethylene vinyl acetate having processing parameters in a range overlapping, or adjacent to, the nylon barrier materials processing parameters, selecting a tie material having processing parameters in a range overlapping the processing parameters of the nylon barrier material and the material based on ethylene vinyl acetate, and co-extruding the nylon barrier material, the tie material and the material based on ethylene vinyl acetate.

In yet another form, the invention is the container liner produced by the co-extrusion process described herein.

In yet another form, the invention is a multilayer liner for use in sealing a container, the liner comprising a co-extrusion of a passive barrier of nylon, a tie layer of adhesive material on the passive barrier of nylon, and two outer layers of non-nylon material.

Other features and advantages of the present invention will become readily apparent from the following detailed description, the accompanying drawings and the appended claims.

### BRIEF DESCRIPTION OF THE DRAWINGS

FIG. 1 is a cross-section of a closure with a liner embodying the invention.

FIG. 2 is a cross-section of the liner embodying the invention.

FIG. 3 is an exploded view of a closure with a liner embodying the invention.

FIG. 3a is a view of section 3a-3a of FIG. 3.

FIG. 4 is a schematic representation of a co-extrusion process that may be used to form the multi-layer co-extruded liners described herein.

FIG. 5 is a graph that depicts the oxygen transmission rate across a sample of ethylene vinyl acetate based material (“EVA”) at 80 percent relative humidity and 100% oxygen concentration.

FIG. 6 is a graph that depicts the carbon dioxide transmission rate across a sample of ethylene vinyl acetate based material (“EVA”) at 80 percent relative humidity and 100% carbon dioxide concentration.

FIG. 7 is a graph that depicts the oxygen and carbon dioxide transmission rates across a sample nylon layer that contains nanoparticles at 100% carbon dioxide concentration and 100% oxygen concentration, respectively.

FIG. 8 is a graph depicting relative humidity at two different temperatures at 5.5° and 23° of about between 95-100% relative humidity in a headspace in a bottle of beer.

FIG. 9 is a graph that depicts the oxygen and carbon dioxide transmission rates across a sample of a multiple layer liner of the present invention at 100% carbon dioxide concentration and 100% oxygen concentration, respectively.

FIG. 10 is a graph depicting the kinetics of oxygen transmission rate for three different multi-layer films at 100% oxygen concentration.

FIG. 11 is a comparison of process temperatures for material layers of a closure liner.

FIG. 12 depicts an example of operating parameters for a run of a process that may be used to produce the multi-layer liners described herein.

FIG. 13 is a graph depicting a range of process temperatures for various nylons and other polymers.

FIG. 14 is a bar graph depicting the adhesive strength of the co-extruded multi-layer liners as measured by T-peel testing.

FIG. 15 is a graph that depicts the removal torque required to remove a closure with a liner of the present invention as compared to a standard liner of ethylene vinyl acetate.

### DETAILED DESCRIPTION OF THE INVENTION

While the present invention is susceptible of embodiment in various forms, there is shown in the drawings and will hereinafter be described a presently preferred embodiment of the invention, with the understanding that the present disclosure is to be considered as an exemplification of the invention and is not intended to limit the invention to the specific embodiment illustrated.

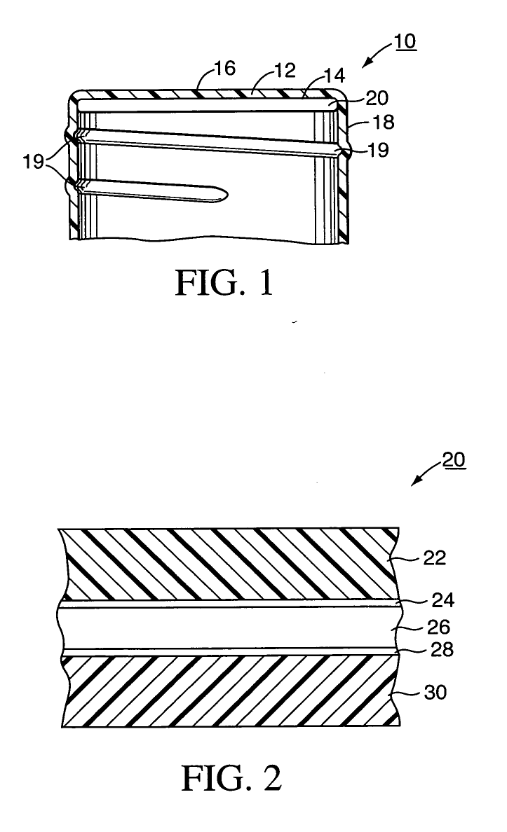

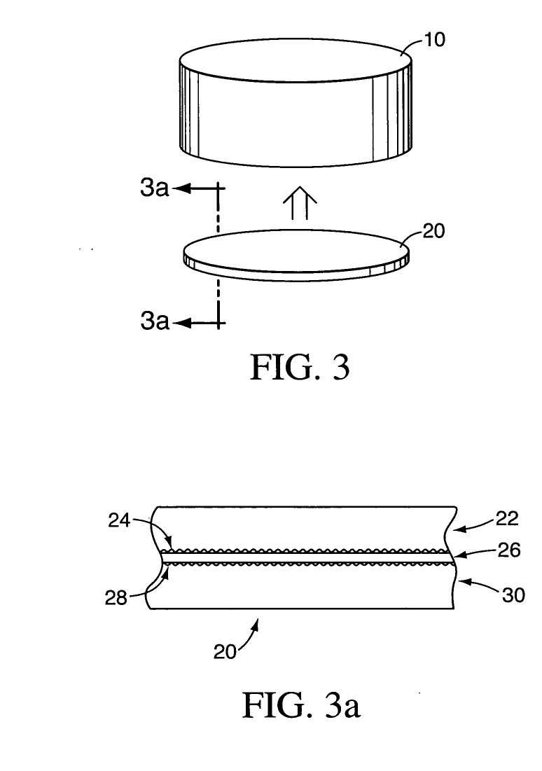

Referring to FIGS. 1-3, a closure 10 has an outer shell 12 with an inside surface 14 of a top wall portion 16, and a cylindrical side wall portion 18 that originates at the top wall portion 16 and depends from the top wall portion 16 as an annular skirt to form a cup-shaped closure 10. The inside surface of the cylindrical side wall portion 18 has helical screw threads 19 that engage corresponding screw threads of an associated container (not shown). A multiple layer liner 20 is positioned adjacent to the inside surface 14 of the top wall portion 16 of the outer shell 12 of the closure 10. For use in container closures, the multiple layer liner 20 may be positioned adjacent to the top wall portion 16 only, or may extend along a portion of the cylindrical side wall portion 18.

The multiple layer liner 20, as depicted in FIG. 2, has an EVA-based material layer 22 attached by a tie layer or adhesive layer 24 to a nylon layer 26. The EVA-based material may be an EVA₁ material or an EVA₂ material. An example of the EVA₁ material layer 22 is DF-6442, commercially available from W.R. Grace in Epernon, France. EVA₁ is based on EVA and another polyolefinic material. An example of EVA₂ material is DF-6601, commercially available from W.R. Grace in Epernon, France. EVA₂ is a mixture of EVA and another polyolefinic material and also a scavenger is incorporated into the mixture. Further, the liner 20 of FIG. 2 in accordance with the preferred form, has a second adhesive layer 28 that bonds the nylon layer 26 to a second layer of EVA-based material 30. The EVA-based material layers 22 and 30 are also known as skin layers because they are the outermost layers of the multiple layer liner 20. The second layer of EVA-based material 30 usually faces the headspace 31 within a container sealed by the closure 10. Several nylon formulations were found to have varying levels of effectiveness as a gas transfer barrier in a closure. One suitable nylon containing the nanoparticles is XA-2908 and is commercially available from Honeywell International in Morristown, N.J. Another nylon, XE-2945, may also be used and is also available from Honeywell. Another suitable nylon is a nylon copolymer, Grivory HB FE 4581, available from EMS Chemie (North America) in Sumter, S.C. The tie layers 24 are typically functionalized polyolefins and may be, for example, PX-108 (“PX”) available from Equistar Chemical Co., Cincinnati, Ohio.

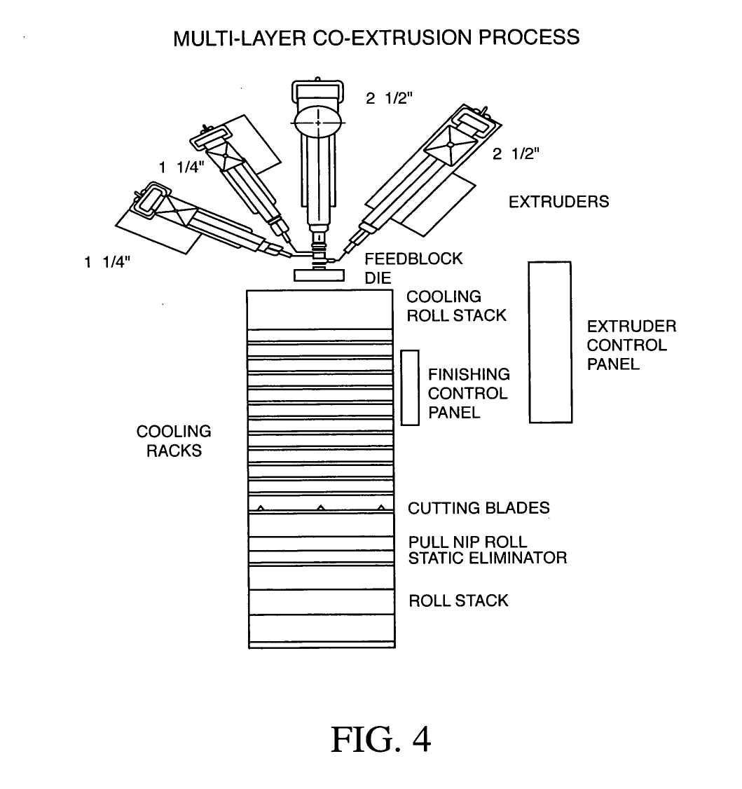

Materials based on EVA in combination with another polyolefinic material have not before been used in multilayer structures. The EVA-layers 22 described here are each of a thickness in the range of about 10 mils to about 12 mils. The tie layers 24 are about 0.3 to 0.8 mils thick, and preferably between about 0.3 and about 0.5 mils. The nylon layer 26 is about 1.0 mil to about 1.5 mils thick. FIG. 4 is a schematic representation of a co-extrusion process that may be used to produce the multi-layer structures described herein

Additional reduction of gas transfer to and from the container may be achieved by the substitution of nylon with a nylon nanocomposite material. The nanoparticles within the nanocomposite material may be, for example, clay particles and may account for about 2% to about 5% by weight of the nylon layer 26. Preferably, the clay particles are mineral clay particles. An example of a suitable inorganic nanoparticle is montmorillonite.

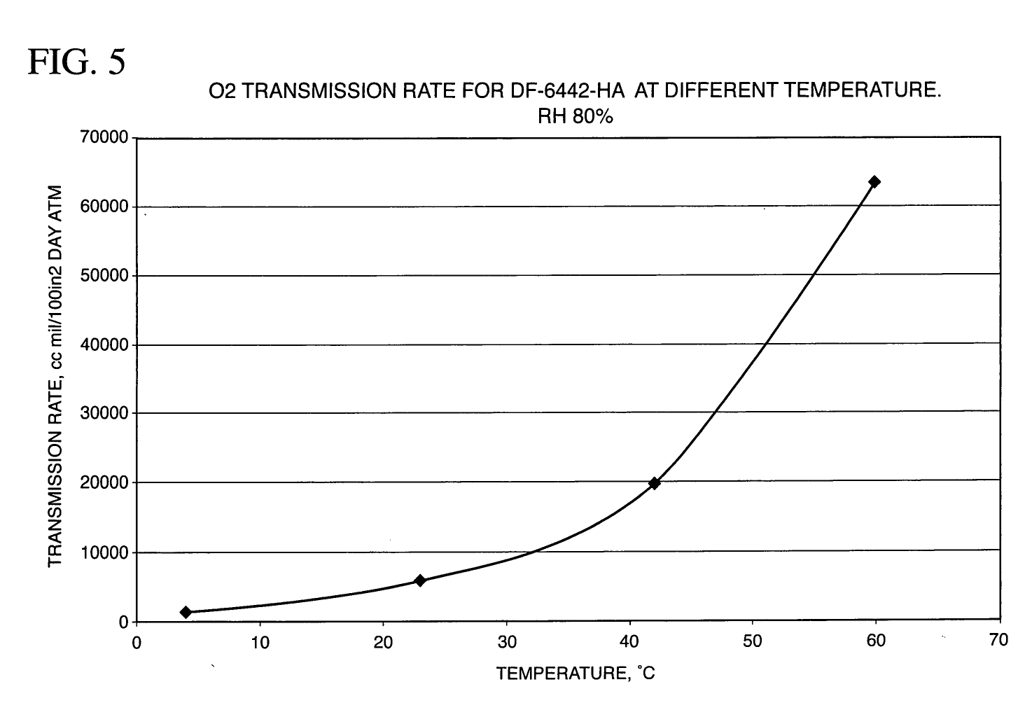

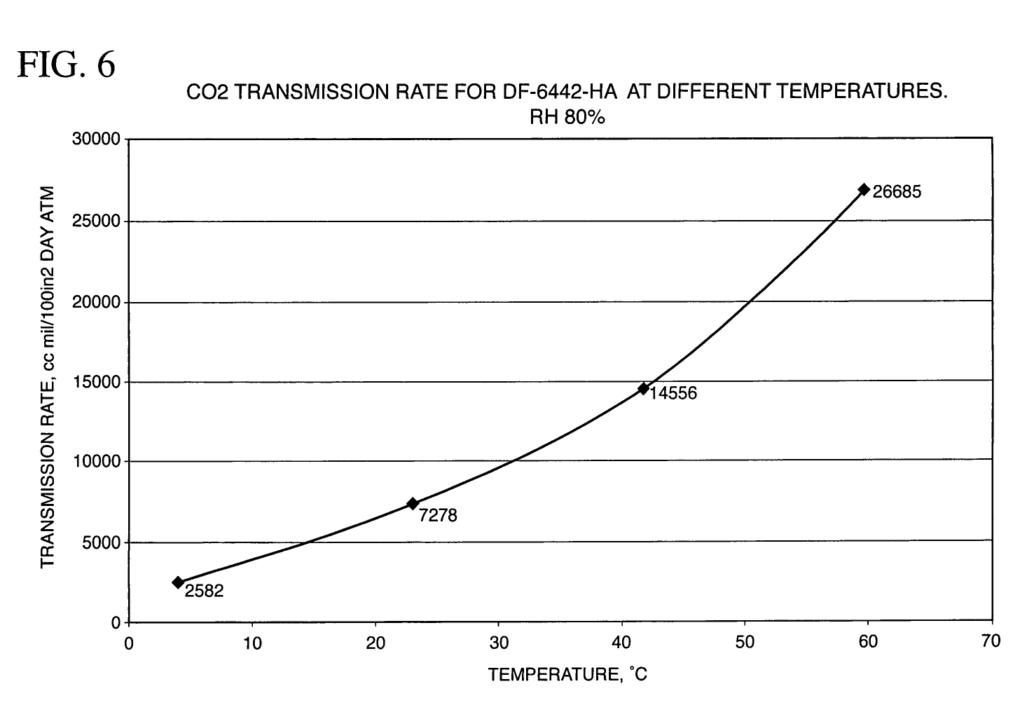

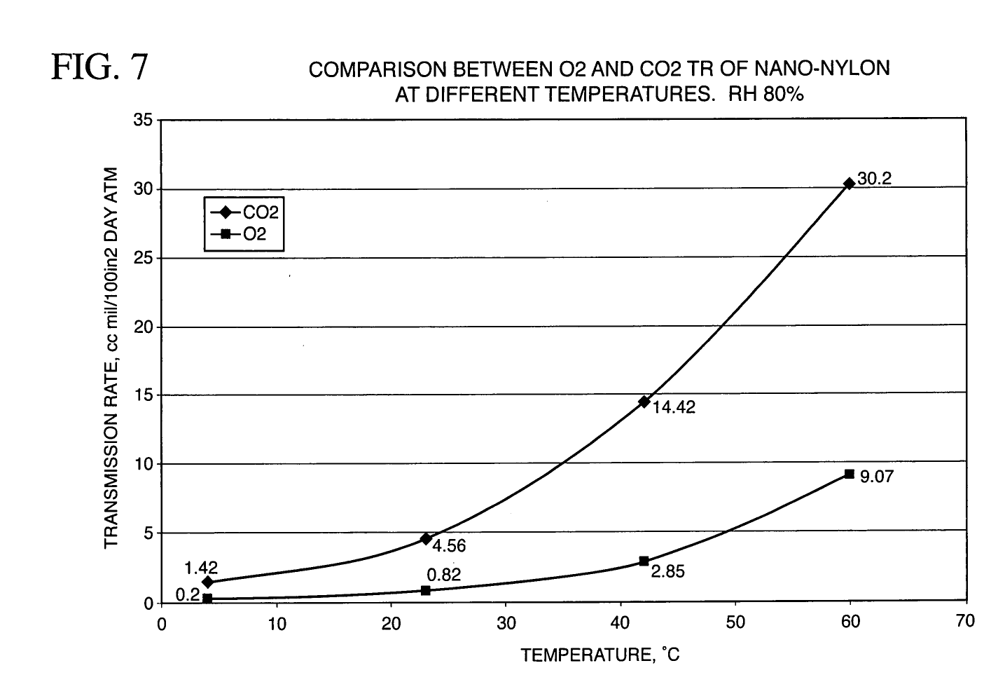

FIG. 5 is a graph depicting the oxygen transmission rate across a sample of EVA, herein known as EVA₁ where the EVA does not contain a scavenger, at varying temperatures. As the temperature exceeds 42° C., the oxygen transmission rate increases significantly. FIG. 6 is a graph depicting the carbon dioxide transmission rate across a sample of EVA₁ at varying temperatures. Similar to the transmission rate increase for oxygen with increasing temperature, the carbon dioxide transmission rate increases significantly at temperatures exceeding 42° C.

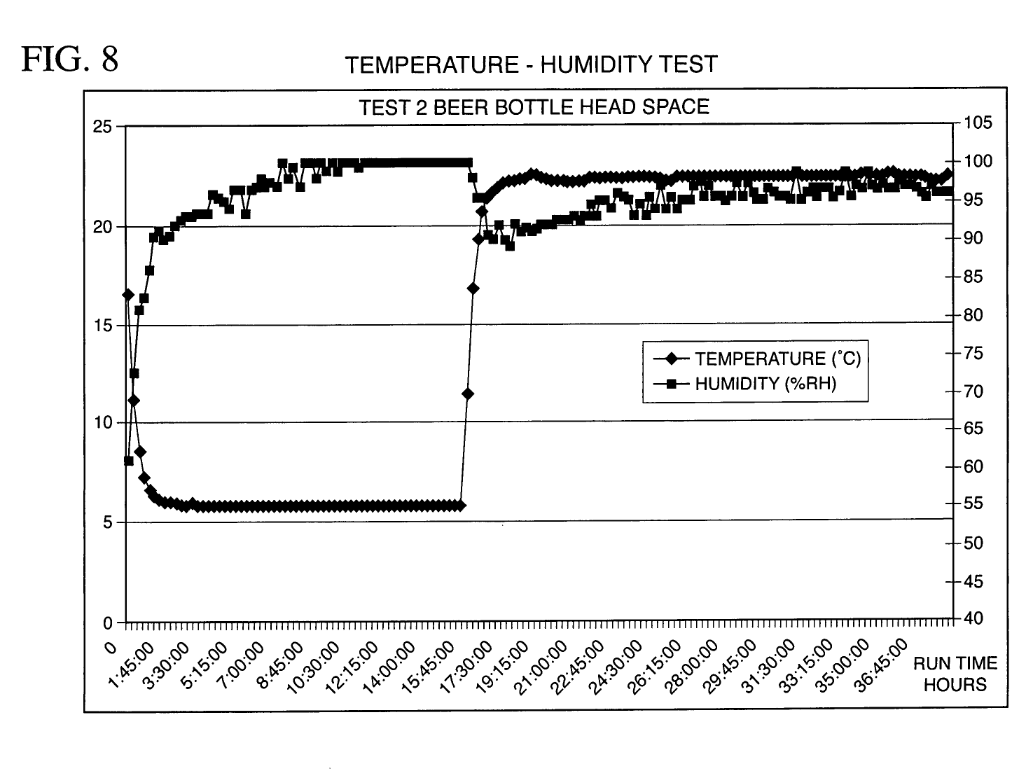

FIG. 7 depicts the oxygen and carbon dioxide transmission rates across a sample of nylon containing the nanoparticles as described earlier. The oxygen transmission rate at 42° C. begins to increase as depicted in FIG. 7, however, the value remains much lower than the oxygen transmission rate across EVA₁ as depicted in FIG. 5. Similarly, the carbon dioxide transmission rate at 42° C. and above in FIG. 7 remains significantly lower than the carbon dioxide transmission rate across EVA₁ as depicted in FIG. 6. Some containers that store beverages obtain relative humidity levels of between 95-100%, such as the levels obtained in bottles of beer as exemplified in FIG. 8. The oxygen permeability of materials in the nylon family perform as well in very high relative humidity environments of 95-100% as they do in moderate relative humidity environments and in environments with relative humidity of between 70-80%. In fact, some nylons, such as MXD-6 perform at the same level or better in the 95-100% relative humidity range than they do in moderate relative humidity environments and in the relative humidity range of 70-80%. Good inhibition of oxygen permeability is important in closure applications.

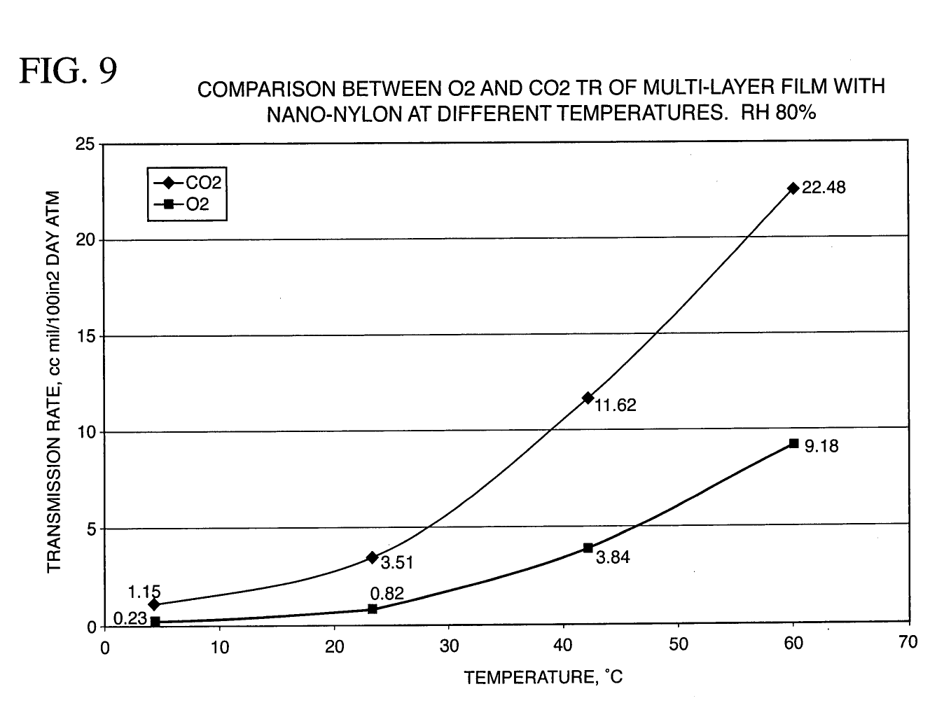

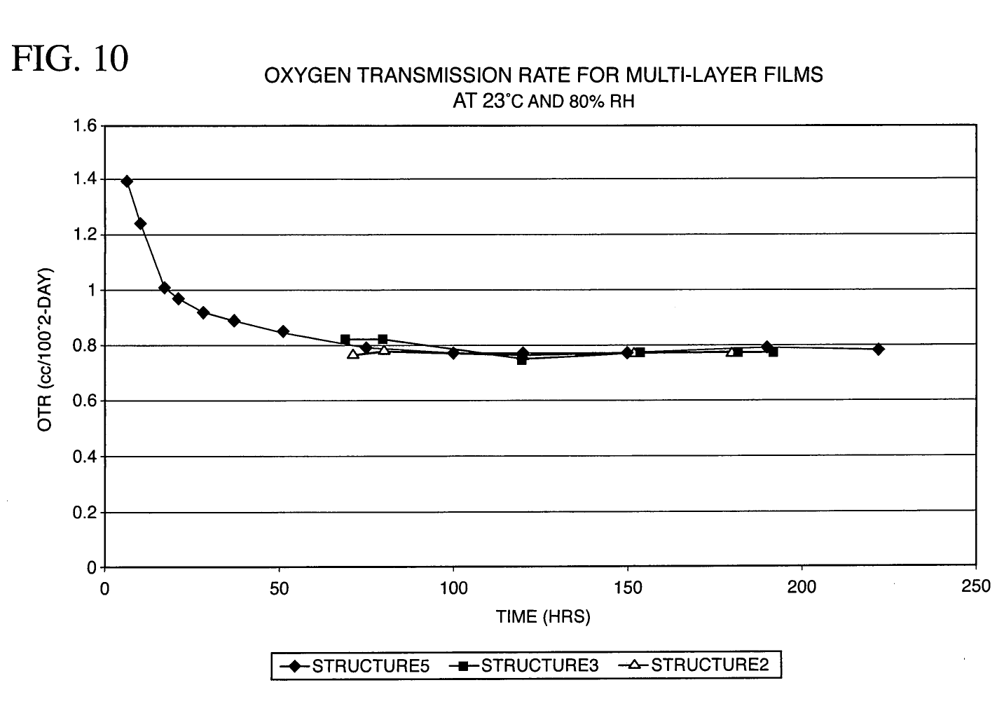

FIG. 9 depicts the oxygen and carbon dioxide transmission rates across a multiple layer film of the configuration depicted in FIG. 2. The oxygen transmission rate is further reduced from the values depicted in FIG. 6. The carbon dioxide transmission rate depicted in FIG. 9 is essentially the same as the rate depicted in FIG. 7. FIG. 8 suggests that the majority of the reduction in oxygen transfer across the liner is due to the passive barrier nylon layer containing the nanoparticles. FIG. 10 depicts the kinetics of oxygen transmission rate across multiple layer films.

The nylon layer 26 of the multiple layer liner 20 acts as a good barrier and significantly inhibits gas transmission to and from the container. Additional active inhibition of gas transmission to and from the container may be achieved by the incorporation of active scavengers to react with oxygen, carbon dioxide, or other transfer gases. Examples of active scavengers are polyamides, sulfite oxygen scavengers and ascorbate in combination with a sulfite. An example of an EVA₂ where the layer contains a scavenger, is DF-6601, described earlier. It is important to have adequate water vapor transmission rate (“WVTR”) through layers of the liner that contain a scavenger in order to provide adequate moisture to the scavenger because moisture is a trigger to begin scavenger activity. In addition to inhibiting oxygen permeability, the EVA-based materials of the present invention also provide WVTR to provide adequate scavenger activity. Another suitable example of EVA₂ is DF-30375, also from W.R. Grace, Epernon, France. Examples of suitable EVA₁ materials (having no oxygen scavenger) include DF-6442, described earlier, and DF-30376, both also available from W.R. Grace, Epernon, France. Active scavengers have a capacity and once the capacity has been utilized, the passive nylon barrier, that may contain nanoparticles, and multiple layers of the liner are still in place. The capacity of the scavenger may be increased within the closure liner by incorporating the scavenger into more than one layer of EVA when multiple layers of EVA are used in the liner. Preferably, the scavenger is included in the EVA layer that is closest to the contents, i.e., facing the headspace 31, of the container to be sealed by the closure 10.

The multiple layer liner 20 is co-extruded, suitably cut and fitted into the container closure 10. The co-extrusion process is simplified by the selection of material layers that have overlapping process parameters, or process parameters that are in a range near to the process parameters of the materials of the adjacent layers. The preferred nylon is XA-2908 This nylon contains nanoparticles that provide an additional passive barrier to gas transfer.

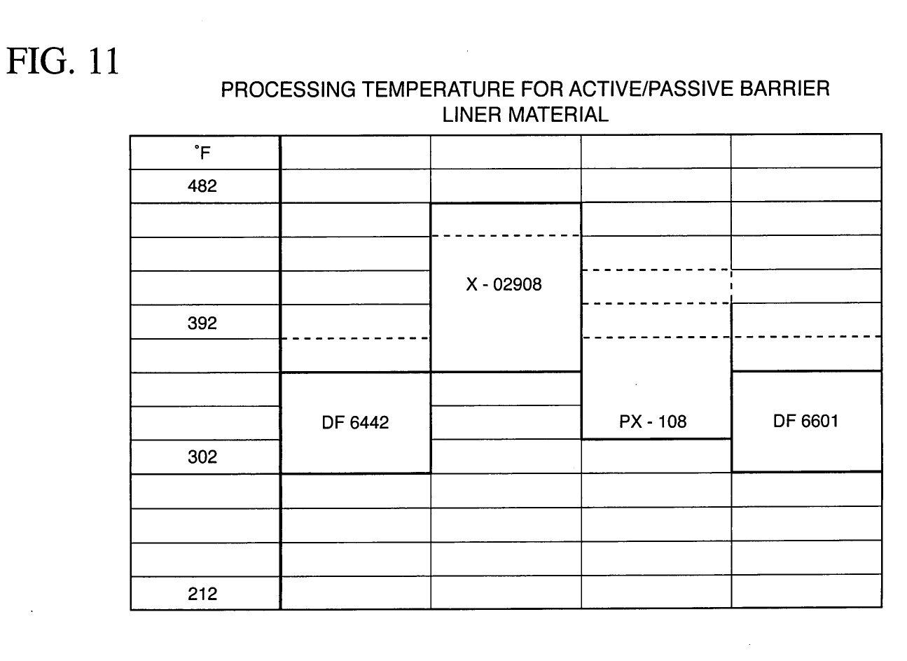

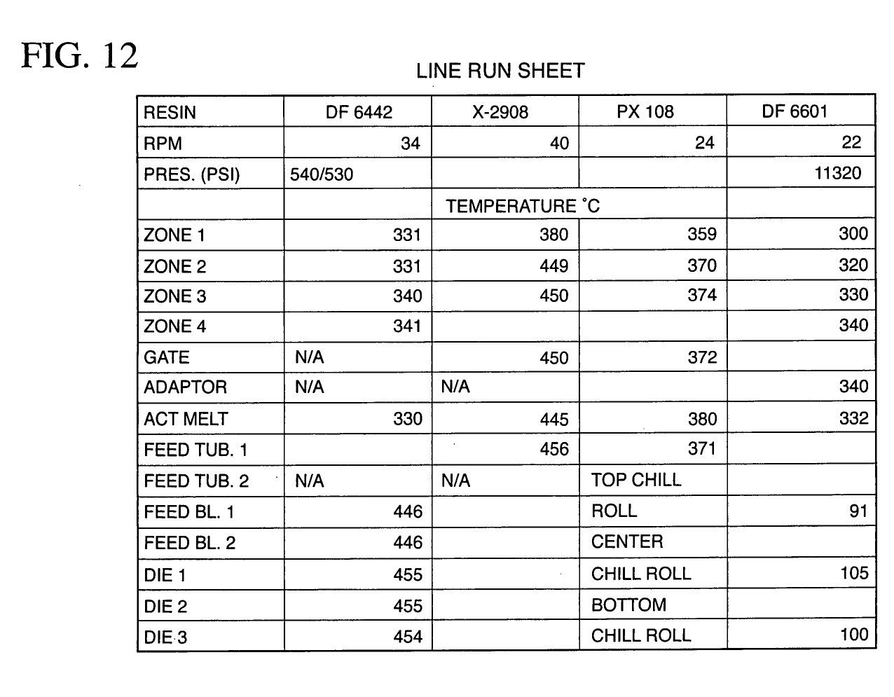

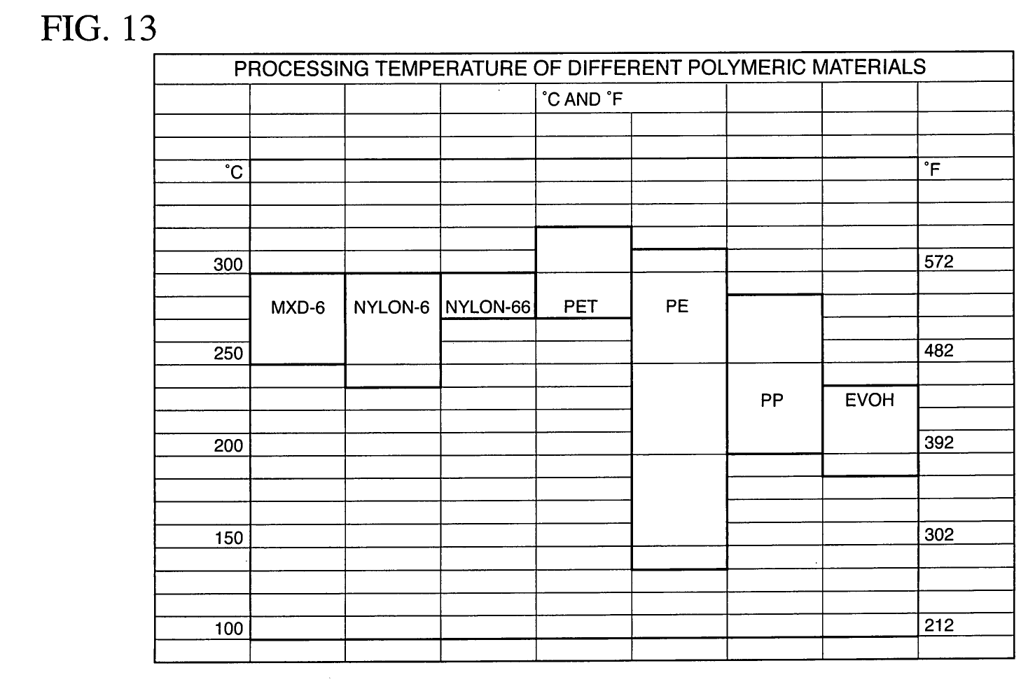

The range of processing temperatures determined by this invention to be useful for co-extruding the materials of the liner are listed in FIG. 11 for each material used in the multiple layer liner. The dashed lines indicate extension beyond the ordinarily acceptable temperature ranges at which these materials are processed according to the invention described herein. The solid lines, such as those that surround DF 6442, DF 6601 and XA-2908 in FIG. 11, indicate standard temperatures at which these materials are known to be successfully processed. The extension of the processing temperature parameter is extended of the co-extrusion for any one material only after the co-extrusions are shown to be stable and reproducible. The materials used are selected for their overlapping or adjacent processing temperature parameter with the materials that will be used in the co-extrusion. Therefore, the liner within the closure of the present invention is a co-extrusion of the materials having similar or overlapping process parameters. FIG. 12 depicts an example of operating parameters for a run of a process that may be used to produce the multi-layer liners described herein. By selecting material layers of the multi-layer liner that have similar or overlapping or adjacent process parameters, the resulting liner is resistant to degradation and delamination. FIG. 13 depicts the standard range of processing temperatures for three types of nylon (MXD-6, Nylon-6, Nylon-66) and four other polymers (polyethylene tetraphthalate (“PET”), polyethylene (“PE”), polypropylene (“PP”) and ethylene vinyl alcohol (“EVOH”)). The diagramming of materials that may potentially be used in combination such as in FIG. 11 or 13, aids in the selection of combinations of materials for co-processing and co-extrusion applications.

Aside from their barrier properties, nylons, such as Nylon 6, are also useful for barrier closures due to their properties of puncture, tear and abrasion resistance, and for their thermo-formability. To obtain the narrowest range of temperatures required for manufacture of the structure of the closures disclosed herein, the nylon 6 preferably has a low melting temperature.

### Determination of Strength of Adhesion

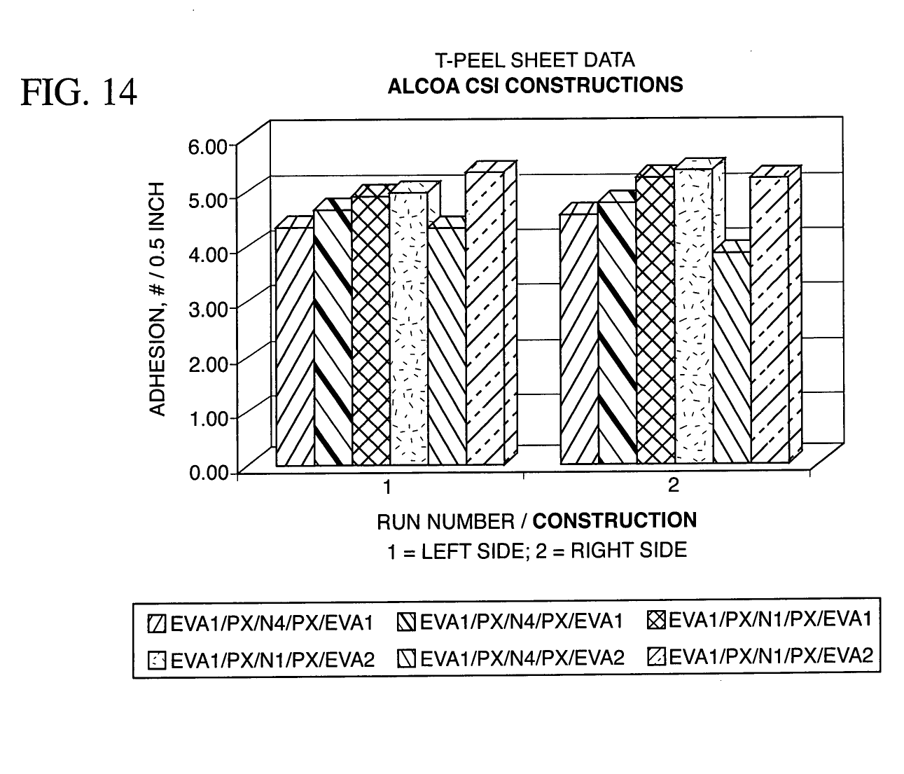

The adhesive load of liners manufactured by this method was analyzed. Samples of the co-extruded multi-layer material were tested as they came off-line and then again after 48 hours or more. The adhesive load was measured using the method prescribed by American Society for Testing and Materials (“ASTM”) D1876-2001. Results from the adhesive test are summarized in Table 1 and depicted in bar graph form in FIG. 14.

For the following example Structures, T-peel testing was used to determine adhesive load as an indication of adhesive strength. These example structures, of course, should not be construed as in any way limiting the scope of the invention.

### Structure 1

This example is the co-extrusion with a core material of the nylon copolymer Grivory HB EF 4581, tie material of PX on both sides of nylon copolymer in the co-extrusion and the EVA₁ known as DF-6442 on both outer surfaces of the laminate. This Structure may be summarized as EVA₁/PX/Grivory HB EF 4581/PX/EVA₁. FIG. 14 includes examples of Structure 1 co-extrusions having both 1 and 1.5 mils thickness of Grivory HB EF 4581.

### Structure 2

This example is the co-extrusion with a core material of the nylon XA-2908, tie material of PX on both sides of XA-2908 in the co-extrusion and the EVA₁ (DF-6442) on both outer surfaces of the co-extrusion. This Structure may be summarized as EVA₁/PX/XA-2908/PX/EVA₁.

### Structure 3

This example is the co-extrusion with a core material of the nylon XA-2908, tie material of PX on both sides of the XA-2908 in the co-extrusion and EVA₁ (DF-6442) on one outer surface of the co-extrusion and the EVA₂ known as DF-6601 on the opposite outer surface of the co-extrusion. This Structure may be summarized as EVA₁/PX/XA-2908/PX/EVA₂. FIG. 14 includes examples of Structure 3 co-extrusions having both 1 and 1.5 mils thickness of XA-2908.

### Structure 4

This example is the co-extrusion with a core material of the nylon copolymer HB EF 4581, tie material of PX on both sides of nylon copolymer in the co-extrusion and the EVA₁ DF-6442 on one outer surface of the co-extrusion and the EVA₂ DF-6601 on the opposite outer surface of the co-extrusion. This Structure may be summarized as EVA₁/PX/Grivory HB EF 4581/PX/EVA₂.

### Structure 5

This example is the co-extrusion with a core material of XA-2908, tie material of PX on both sides of the XA-2908 the co-extrusion and the EVA₂ DF-6601 on both opposite, outer surfaces of the co-extrusion. This Structure may be summarized as EVA₂/PX/XA-2908/PX/EVA₂.

TABLE 1
Summary Of T-Peel Testing (ASTM D1876-2001) Of Individual
Sheet Specimens 1-4 (reported in pounds per inch).

| Structure | Spec. 1 | Spec. 2 | Spec. 3 | Spec. 4 | Avg. | Std. Dev. |
|---|---|---|---|---|---|---|
| 1 | 8.72 | 9.74 | 8.08 | 8.30 | 8.72 | 0.84 |
| 1 | 7.82 | 10.30 | 9.50 | | 9.20 | 1.26 |
| 1 | 9.46 | 9.40 | 9.02 | | 9.30 | 0.24 |
| 1 | 10.02 | 9.10 | 9.60 | | 9.58 | 0.46 |
| 2 | 9.24 | 8.98 | 11.24 | | 9.82 | 1.24 |
| 2 | 9.84 | 11.68 | 9.88 | | 10.46 | 1.06 |
| 3 | 10.42 | 9.58 | 9.40 | 10.44 | 9.96 | 0.54 |
| 3 | 10.44 | 10.30 | 11.00 | 11.14 | 10.72 | 0.38 |
| 4 | 9.62 | 7.52 | 8.60 | | 8.58 | 1.06 |
| 4 | 9.76 | 7.58 | 5.80 | | 7.72 | 1.98 |
| 3 | 9.70 | 10.76 | 11.66 | | 10.70 | 0.98 |
| 3 | 11.72 | 7.90 | 11.17 | | 10.44 | 2.20 |

### Removal Torque Testing

Removal torque was tested across a range of time and conditions. Containers with closures applied were cycled through several conditions and tested at various stages for removal torque. Bottles sealed with the closures having the multi-layer co-extruded liners described herein where moved from one controlled temperature area to another as described. Containers sealed with the standard multi-layer EVA (“Tri-Shield”) liner material included an EVOH barrier layer. The standard EVA liner is a nine-layer liner with EVOH as a barrier layer. Closures with liners were sealed onto containers and conditioned at a temperature of 95° F. for two days and then stored at ambient temperature (roughly 70° F.) for 24 hours. Removal torque was then measured. Then containers were conditioned at 40° F. for 10 days and transferred to ambient temperature for 24 hours prior to having removal torque tested. Then the closed containers were conditioned at 95° F. for two days and then returned to ambient temperature for 24 hours prior testing removal torque. Then the closed containers were conditioned again at 40° F. for 10 days, returned to ambient temperatures for 24 hours and tested for removal torque.

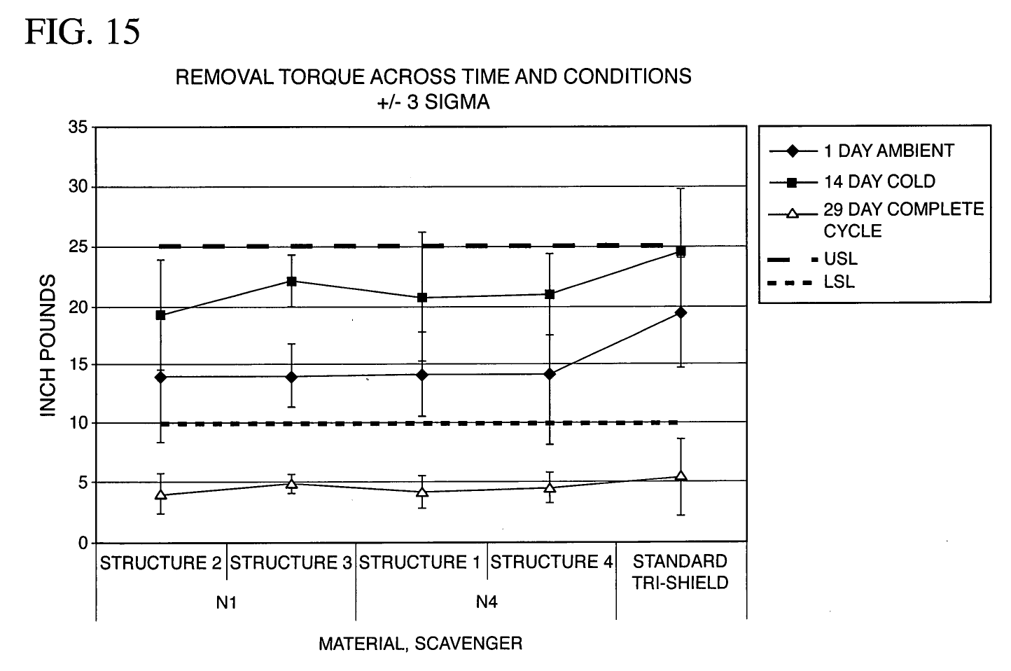

Closures containing the multiple layer liner with a nylon core were similarly sealed onto containers, conditioned and stored. FIG. 15 depicts a graph comparing the torque required to remove the closures from the containers. The term “N1” generally refers to Structures 2, 3, and 5 described herein and the term “N4” generally refers to Structures 1 and 4 described herein. The multiple layer liner with the nylon core performs better than the standard material and does not require significant additional torque to open the container under any of the conditions observed.

Closures 10 having only a passive nylon barrier 26 and a tie layer 28 bonding a layer of EVA₁ or EVA₂ material 30 to the passive nylon barrier also serve as good barriers against ingress and egress of gases such as oxygen, carbon dioxide and nitrogen. The EVA₁ or EVA₂ layer 28 will face the headspace 31 and form a seal with the container.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A process for manufacturing a container closure liner, the process comprising the steps of:
selecting a nylon barrier material having a range of processing temperature parameters;
selecting a material based on ethylene vinyl acetate having processing temperature parameters in a range overlapping, or adjacent to, the nylon barrier materials processing temperature parameters;
selecting a tie material having processing temperature parameters in a range overlapping the processing temperature parameters of the nylon barrier material and the material based on ethylene vinyl acetate; and
co-extruding the nylon barrier material, the tie material and the material based on ethylene vinyl acetate.

18. (canceled)

19. (canceled)

20. (canceled)

21. A method of manufacturing a liner material, the method comprising:
(a) providing a nylon barrier layer material having an extrusion processing temperature range;
(b) providing one or more skin layer materials selected separately for each occurrence from EVA, EVA copolymers, and blends of each with polyolefin polymers wherein each said skin layer material optionally contains an active oxygen scavenging material, and wherein the processing temperature range of each of said skin layer material overlaps with or is adjacent to said nylon barrier material processing temperature range;
(c) providing one or more tie layer compositions compatible with said nylon barrier layer material and said skin layer material(s) wherein each said tie layer composition has a processing temperature range overlapping with the processing temperature ranges of said nylon barrier material and with at least one said skin layer material; and
(d) co-extruding materials provided in steps “a” to “c” to provide a multi-layered composite material having a nylon barrier layer, adhered to each of a first and second face thereof a layer comprising at least one tie layer composition, and adhered to a face of each tie layer material distal to said barrier layer, a layer of skin layer material compatible with said tie layer.

22. The method of claim 21, wherein the liner material is further characterized as having a peel test rating between each said polymer layer and said nylon layer of at least 8 lbs. force/inch as measured by ASTM method D 1876-2001.
